(19) United States
(12) Patent Application Publication
(10) Pub. No.: US 2009/0070208 A1
(43) Pub. Date: Mar. 12, 2009

(54) Method of developing the activity of an on-line payment site by means of an attractor site interfaced therewith

(76) Inventor: Roland Moreno, Paris (FR)

Correspondence Address: JACOBSON HOLMAN PLLC, 400 SEVENTH STREET N.W., SUITE 600, WASHINGTON, DC, 20004, US

(21) Appl. No.: 11/898,472

(22) Filed: Sep. 12, 2007

(51) Int. Cl. G06Q 40/00; G06Q 30/00

(52) U.S. Cl. 705/14; 705/38

(57) ABSTRACT

The invention provides an economic mechanism enabling an on-line payment site to be developed by means of an attractor site that is distinct but that is interfaced to a payment site. The method of the invention comprises the following steps: a) after an individual has connected to the attractor site, giving the individual an option for accessing a specific game function; b) if the individual decides to access said specific game function, and if the individual is not a user affiliated with the payment site interfaced with the attractor site, presenting the individual with an affiliation form for the payment site and affiliating the individual; c) presenting the individual with a question generated by a question engine of the attractor site; d) collecting the answer provided by the individual; e) comparing the answer provided with a reference answer known to the attractor site, and calculating a score as a function of the difference observed between the answer provided and the reference answer; and f) as a function of said score, optionally allocating a sum credited to the account allocated to the individual on the on-line payment site. The attractor site may be a search engine and the question may be a question relating to a quantified parameter associated with the activity of the attractor site, for example the relative frequency of terms that are present the most often in the requests submitted to the search engine over a given period, typically a daily period.

### CONTEXT OF THE INVENTION

1. Field of the Invention

The invention relates to a method of developing the activity of an on-line payment site.

On-line payment sites, also known as “Internet payment solutions” are Internet sites making it easier for Internet users to make purchases from merchant sites.

The merchant site is affiliated with the on-line payment site. An Internet user seeking to make or receive on-line payments needs to open an account with the payment site, after communicating his or her own identity and bank information.

Once registered, the Internet user can send and receive payments over the Internet solely by means of an email address, without it being necessary to provide details, and in particular bank card number, on each transaction. The user can send money to any person (in particular to a merchant site) also possessing an account with the payment site; conversely, the user can make use of the funds available on the balance of his or her account with the payment site, or coming from other sources and transferred to said account. Each transaction is notified to the parties involved by email confirming execution of the transfer of money.

Google Checkout and PayPal (registered trademarks) are two of the best-known examples of such payment sites.

These sites are particularly well adapted to making “micropayments”, i.e. payments for very small amounts, a few dollars or even less than a dollar, amounts that cannot be passed via traditional bank transfers since the bank fees would be disproportionate.

2. Description of Related Art

Methods are known that are specifically intended for developing the activity of an Internet site, for example the method described in co-pending application U.S. Ser. No. 11/802,774 filed May 24, 2007 (Moreno) and entitled A method of developing the activity of an on-line game site, which is incorporated herein by reference.

That application discloses a method based on a game that gives the player a real hope of winning, but without requiring the player to make any stake whatsoever. The method seeks to use the game to create an economic mechanism for which development is self-sustaining. The activity of the site is measured by a traffic index representative of the number of players who have participated in the game over a given time interval. To increase the activity, a large fraction of the advertising revenues generated is shared amongst the largest possible number of players, so as to set up emulation amongst existing and potential players. As the advertising revenues and the activity of the game increase, so the number of players will increase as will the number of advertisers, and the greater the number of advertisers, the greater the revenues, and the greater the revenues the greater the sums that can be shared amongst players. Once an initial priming stage is over, the mechanism is self-sustaining, forming a “virtuous circle”.

### SUMMARY OF THE INVENTION

The object of the present invention is to create an economic mechanism that is likewise based on a game, but that does not (or not essentially) set out to develop the site hosting the game, but rather to develop an on-line payment site that is distinct from the site hosting the game but that is interfaced therewith.

The on-line payment site manages a set of accounts allocated to affiliated users, which accounts can be used for making and receiving monetary payments on line between the accounts of affiliated users.

The method of the invention comprises the following steps:

a) after an individual has connected to the attractor site, giving the individual an option for accessing a specific game function;

b) if the individual decides to access said specific game function, and if the individual is not a user affiliated with the payment site interfaced with the attractor site, presenting the individual with an affiliation form for the payment site and affiliating the individual;

c) presenting the individual with a question generated by a question engine of the attractor site;

d) collecting the answer provided by the individual;

e) comparing the answer provided with a reference answer known to the attractor site, and calculating a score as a function of the difference observed between the answer provided and the reference answer; and

f) as a function of said score, optionally allocating a sum credited to the account allocated to the individual on the on-line payment site.

The question is preferably a closed-answer question of the multiple-choice type, e.g. a question comprising classifying multiple choices. Under such circumstances, presenting the question in step c) may comprise displaying on the screen a series of fields that can be moved by controlled action of the individual, so as to drag the fields over the screen and set up an order that is representative of the answer being made.

In particular, presenting the question in step c) may include displaying an advertising field.

In a particular implementation, the method includes a prior step of periodically establishing an endowment for sharing over a given time period between a predefined number of individuals, the endowment being the total of all the sums actually allocatable to individuals over the given period of time, typically a period of several days. In particular, presenting the question in step c) may include displaying at least one paid-for advertising insertion field, with the endowment then being a function of the revenues generated by said paid-for advertising insertion.

Step f) of optionally allocating a monetary value is then executed only at the end of said given time period, and it comprises: classifying participating individuals who have obtained the best scores over said given time period; selecting from them, those who have obtained the highest scores; and sharing the endowment between the individuals as selected in this way. The sharing may be weighted between a plurality of classes of individuals grouped together as a function of their scores, the individuals in the higher classes each receiving a larger sum, and vice versa.

According to another aspect of the invention, presenting the question in step c) includes displaying at least one paid-for advertising insertion field established on the basis of a given tariff, and the method further comprises the steps of: i) measuring the activity of the attractor site by a traffic index representative of the number of individuals who have accessed said specific game function during a given time interval; ii) evaluating the revenues associated with said paid-for advertising insertion(s); iii) determining an amount for the endowment as a function of said revenues; iv) on detecting an increase in the traffic index above a given threshold, correspondingly increasing at least one of: the tariff for advertising insertions and the space allocated to said advertising insertions; v) on detecting an increase in said revenues above another given threshold, correspondingly increasing the amount of said endowment; and vi) reiterating steps iv) and v) above.

Advantageously, the attractor site is a search engine and the question is a question relating to a quantified parameter associated with the activity of the attractor site. The quantified parameter may, in particular, be the relative frequency of terms present the most often in the requests submitted to the search engine over a given period of time, typically a daily period. Step c) of presenting the question may then include selecting a small subset of n terms from a larger set of the N terms present the most frequently in the requests submitted during the given period, and then presenting these n terms to the individual, with the question consisting in asking the individual to classify these n terms.

### DESCRIPTION OF THE PREFERRED IMPLEMENTATION

As mentioned above, the invention implements two sites that are distinct but that interface each other, namely an on-line payment site of the type described in the introduction and refereed to below as the “payment site”, and another site, referred to as the “attractor site”.

For the attractor site, a site should be selected that is characterized by its very large number of visitors, e.g. a search engine, although that example is not limiting.

When a request is made on a search engine, the engine returns a results page headed by a line giving various fields in which searching can be undertaken. For example, the Google® search engine presents the following line:

| | | | | |
|---|---|---|---|---|
| Web | Images | Groups | News | more>> |

To implement the invention, an additional option referred to as “Hit” is added to this series of headings, which becomes:

| | | | | | |
|---|---|---|---|---|---|
| Web | Images | Groups | News | Hit | more>> |

This additional option is to enable an Internet user who so desires to access a game function integrated in the search engine.

If the Internet user does not desire to play, then this function is merely ignored and the search engine is interrogated in the usual way.

In contrast, a user who does want to play merely clicks “Hit”. At which stage, either:
the user is already logged into the “Hit” game and the search engine will set a new test;
or else the user is not yet logged in, and will be invited to do so in entirely conventional manner by the search engine presenting a questionnaire to be filled in with an email address, a login, a password, a cell phone number, and a test of the Captcha® type for distinguishing between a human user and a robot, etc.

Thereafter, a special window opens including a zone for the game and an advertisement zone.

In the game zone of the window there is displayed a question that is put to the player.

In the advertisement zone, there is displayed an advertisement together with a link, e.g. to a well-known trademark seeking to sponsor the game.

Numerous games can be envisaged. The example given below is not limiting in any way, and has merely been selected because of its simplicity and because it enables the player to achieve a winning, even if small, under practically all circumstances, something that will increase interest in the game and thus the attractiveness of the site.

The question put to the Internet user is preferably a closed-answer question of the multiple-choice type.

The choice given to the user may, for example, be presented in the form of a grid with a series of boxes, with the player clicking in a box to make a selection.

It is also possible to ask the player to sort a certain number of headings that are presented to the player, or to select and/or sort three, four, or five headings from some larger number that are proposed.

For example, when the attractor site is a search engine, it knows from its own statistics, for example which are the hundred words that have led to the greatest number of requests during the preceding day. This data is known to the site, but it is not publicly accessible, and it can therefore serve as a basis for the game.

Among those hundred words, six of them are drawn at random and are presented in the wrong order to the Internet user.

The user is asked to classify the six words in decreasing order, going from the word the user believes to be present the most often in the one hundred words in question, to the word the user believes to be present the least often.

Advantageously, the questions and the way in which the answers are made can involve a graphics interface so that the game can be played solely by manipulating the mouse in order to answer the questions, without making use of the keyboard. By way of example, the six words drawn at random are displayed on the screen in the wrong order, and the player answers by dragging the fields corresponding to each word so as to stack the words, with the preferred word being at the top of the stack.

A button serves to confirm the answer and send it to the attractor site.

On the basis of the answer, the attractor site determines a score, which is displayed in return to the player.

Most advantageously, the score is calculated from a multitude of different criteria, with a greater or smaller number of points being allocated to the player depending on whether or not a criterion is satisfied.

Table 1 below gives an example of such criteria, with varying numbers of points being associated with each criterion.

TABLE 1

| | |
|---|---|
| one item in the right place | 3 points |
| two items in the right place | 5 points |
| three items in the right place | 7 points |
| four items in the right place | 11 points |
| five items in the right place | 13 points |
| four items in the right place including second place | 17 points |
| two items in order | 19 points |
| three items in order | 23 points |
| the winner | 29 points |
| the loser | 31 points |
| number two | 37 points |
| number three | 41 points |
| number four | 43 points |
| number four and number six | 47 points |
| number five and number three | 53 points |
| number six and number three | 59 points |
| a series of two items | 61 points |
| two series of two items | 97 points |
| three series of two items | 109 points |
| one series of three times | 113 points |
| two series of three items | 139 points |
| one series of four items | 181 points |
| one series of five items | 997 points |
| number one and number three | 71 points |
| number one and number four | 73 points |
| alternate items in the right and wrong places | 83 points |
| even rank items in the right place | 89 points |
| even rank items in the right place except 1 | 97 points |
| even rank items in the right place except 3 | 101 points |
| odd rank items in the right place | 103 points |
| items of rank that are multiples of 3 in the right place | 107 points |
| items of rank that are multiples of 3 in the right place | 173 points |
| except 1 . . . | |
| items of prime number rank in the right place | 359 points |
| items of prime number rank in the right place, except 1 | 269 points |
| items of [prime plus 1] rank in the right place except 2 | 157 points |
| items of [multiple of 2] rank in the right place except 1 | 241 points |
| numbers 3 and 5 in the right place | 127 points |
| number 4 in the right place | 401 points |
| number 5 in the right place | 419 points |

The points corresponding to each criterion are added together to give a final score. This method of calculating the score from a multitude of criteria taken in combination and producing results that are added together presents two advantages:
the Internet user will almost certainly score some points; the probability is very low that an answer will not satisfy at least one of the criteria, even if only a criterion having a very low performance index;
the probability of obtaining identical scores with different combinations is relatively low (thus leading to small risk of ties), particularly when a large number of criteria are made available, and if well-chosen point values are given to the criteria, in particular values that are different and that present between them few or no common dividers.

At regular intervals, e.g. every day or every week, the Internet users who have played the game are classified as a function of the scores they have obtained, and a prize of monetary value is allocated to them, e.g. in application of Table 2 below.

TABLE 2

| Rank | Gain | Per week | |
|---|---|---|---|
| 1 | 10,000 | 1 | 10,000 |
| 2 | 1,000 | | |
| 3 | 1,000 | | |
| 4 | 1,000 | | |
| 5 | 1,000 | | |
| 6 | 1,000 | | |
| 11 | 1,000 | 10 | 10,000 |
| 12 | 100 | | |
| | 100 | | |
| 13 | 100 | . . . | |
| 14 | 100 | . . . | |
| 111 | 100 | 100 | 10,000 |
| 112 | 10 | | |
| 113 | 10 | | |
| 1,111 | 10 | 1,00 | 10,000 |
| 1,112 | 1 | | |
| 11,111 | 1 | 10,000 | 10,000 |
| 11,112 | 0 | | |

The prize obtained by the Internet user will be credited to that user on the account the user holds with the on-line payment site.

Users who do not have such an account will be invited to open one so as to be able to receive without delay payment for the winnings they have obtained.

The object of the invention is to encourage Internet users who do not have an account with the on-line payment site interfaced with the attractor site (or who have an account but with a different on-line payment site), to open such an account.

The Internet user may be requested to open an account with the on-line payment site in several stages: when logging on to the game after clicking on the “Hit” heading, and/or when a prize allocated to each user is determined after sorting all the users who played during a given period, and/or at any intermediate stage of the game.

Since the number of accounts opened on the on-line payment site will be larger with an attractor site that has a large amount of traffic, it is desirable to encourage growth in that traffic.

This growth can be obtained in particular by the technique described in the above-mentioned pending application U.S. Ser. No. 11/802,774 (Moreno) incorporated herein by reference, and to which reference can be made for more ample details.

Essentially the method consists in provoking emulation amongst existing and potential Internet users that leads to a “virtuous circle” enabling the activity of the site to be increased, and correspondingly increasing its advertising revenues, the endowment available for prizes, and thus the attractiveness of the game.

For example, the site may make a daily endowment as a function of advertising revenue and can make it known that, henceforth, it will pay players 50%, for example, of those receipts, distributed in the manner specified above in Table 2.

This outlook greatly increases the interest of Internet users, who will crowd in ever increasing daily numbers on the site.

This enables the operator of the site to increase advertising tariffs accordingly, thereby increasing revenues and thus also the endowment that can be offered to players, since the endowment is indexed on the advertising revenues.

This increase in the endowment will itself lead to an increase in traffic, thus enabling advertising tariffs to be further raised, thereby raising revenues, and so on, triggering the above-mentioned “virtuous circle” suitable for further increasing the activity of the site.

1. A method of developing the activity of an on-line payment site by means of an attractor site interfaces with said on-line payment site,
in which the on-line payment site manages a set of accounts allocated to affiliated users, these accounts being usable for making and receiving on-line monetary payments between the accounts of affiliated users,
the method comprising the following steps:
a) after an individual has connected to the attractor site, giving the individual an option for accessing a specific game function;
b) if the individual decides to access said specific game function, and if the individual is not a user affiliated with the payment site interfaced with the attractor site, presenting the individual with an affiliation form for the payment site and affiliating the individual;
c) presenting the individual with a question generated by a question engine of the attractor site;
d) collecting the answer provided by the individual;
e) comparing the answer provided with a reference answer known to the attractor site, and calculating a score as a function of the difference observed between the answer provided and the reference answer; and
f) as a function of said score, optionally allocating a sum credited to the account allocated to the individual on the on-line payment site.

2. The method of claim 1, in which said question is a closed-answer question of the multiple-choice type.

3. The method of claim 2, in which said question comprises classifying said multiple choices.

4. The method of claim 3, in which presenting the question in step c) comprises displaying on a screen a series of fields that can be moved by controlled action of the individual so as to drag the fields on the screen and set up an order representative of the answer being formulated.

5. The method of claim 1, in which presenting the question in step c) further comprises displaying an advertising field.

6. The method of claim 1, further comprising a prior step of periodically allocating an endowment for sharing over a given period of time between a predefined number of individuals, said endowment being the total of all the sums actually allocatable to individuals over said given period of time.

7. The method of claim 6, in which:
presenting the question in step c) further comprises displaying at least one paid-for advertising insertion field; and
said endowment is a function of the revenues generated by said paid-for advertising insertion.

8. The method of claim 6, in which said given time period for sharing the endowment is a period of several days.

9. The method of claim 6, in which said step f) of optionally allocating a monetary value is implemented only at the end of said given time period, and comprises:
classifying the participating individuals who have obtained the best scores over said given time period;
selecting from them those who have obtained the highest scores; and
sharing the endowment between the individuals selected in this way.

10. The method of claim 9, in which the endowment is shared between the selected individuals with weightings between a plurality of classes of individuals grouped as a function of their scores, the individuals in the higher classes each receiving a larger sum, and vice versa.

11. The method of claim 6, in which:
presenting the question in step c) further comprises displaying at least one paid-for advertising insertion field established on the basis of a given tariff, and
the method further comprises the steps of:
i) measuring the activity of the attractor site by a traffic index representative of the number of individuals who have accessed said specific game function during a given time interval;
ii) evaluating the revenues associated with said paid-for advertising insertion(s);
iii) determining an amount for the endowment as a function of said revenues;
iv) on detecting an increase in the traffic index above a given threshold, correspondingly increasing at least one of: the tariff for advertising insertions and the space allocated to said advertising insertions;
v) on detecting an increase in said revenues above another given threshold, correspondingly increasing the amount of said endowment; and
vi) reiterating steps iv) and v) above.

12. The method of claim 1, in which the attractor site is a search engine.

13. The method of claim 1, in which said question is a question relating to a first quantified parameter associated with the activity of the attractor site.

14. The method of claim 13, in which:
said attractor site is a search engine; and
said parameter quantifies the relative frequency of terms that are present the most often in requests submitted to the search engine over a given period.

15. The method of claim 14, in which said given time period for submitting requests is a daily period.

16. The method of claim 14, in which:
step c) of presenting the question comprises selecting a small subset of n terms from a larger set of N terms used the most frequently in the requests submitted during the given period, and then presenting the n terms to the individual; and
the question consists in asking the individual to classify said n terms.
